(19) United States
(12) Patent Application Publication
(10) Pub. No.: US 2009/0011283 A1
(43) Pub. Date: Jan. 8, 2009

(54) Hcp soft underlayer

(75) Inventors: Erol Girt, Berkeley, CA (US); Raj N. Thangaraj, Fremont, CA (US)

Correspondence Address: Seagate Technology;c/o DARBY & DARBY P.C., P.O. Box 770, Church Street Station, New York, NY, 10008-0770, US

(73) Assignee: SEAGATE TECHNOLOGY LLC, Scotts Valley, CA (US)

(21) Appl. No.: 11/712,559

(22) Filed: Mar. 1, 2007

(51) Int. Cl. G11B 5/73; B05D 5/12

(52) U.S. Cl. 428/846; 427/131

(57) ABSTRACT

A perpendicular magnetic recording medium of the embodiments of the invention comprises a substrate, a hcp soft underlayer (SUL), and a magnetic layer, wherein the hcp SUL is adapted to create a [0002] growth orientation in the magnetic layer and to enhance a magnetic head field during writing of data to the magnetic layer; further wherein the perpendicular magnetic recording medium does not contain an interlayer (IL) that is different from the hcp SUL and provides a [0002] growth orientation in the magnetic layer.

### RELATED APPLICATIONS

None.

### FIELD OF INVENTION

The present invention relates to improved, high recording performance magnetic recording media comprising an hexagonal closed packed (hcp) soft underlayer (SUL) that can perform the roles of an interlayer, which typically sets the [0002] growth orientation, and that of SUL.

### BACKGROUND

Thin film magnetic recording media, wherein a fine-grained polycrystalline magnetic alloy layer serves as the magnetic recording layer, are generally classified as “longitudinal” or “perpendicular,” depending on the orientation of the magnetic domains (bits) of the grains in the magnetic recording layer. FIG. 1, obtained from Magnetic Disk Drive Technology by Kanu G. Ashar, 322 (1997), shows magnetic bits and transitions in longitudinal and perpendicular recording.

Besides magnetic recording layer/s (ML), perpendicular magnetic media also includes an interlayer (IL) and soft magnetic underlayer (SUL). The role of IL is to provide the [0002] growth orientation, and to establish a surface roughness and a physical grain separation required for an oxide segregation to the grain boundaries. For this reason IL consists of two layers, one layer is used to establish the [0002] growth orientation and the role of the other layer is to provide required surface morphology. The SUL is used to enhance the magnetic head field during the writing process.

### SUMMARY OF THE INVENTION

The embodiments of the invention are directed to a perpendicular magnetic recording medium comprising a substrate, a hcp soft underlayer (SUL), and a magnetic layer, wherein the hcp SUL is adapted to create a [0002] growth orientation in the magnetic layer and to enhance a magnetic head field during writing of data to the magnetic layer; further wherein the perpendicular magnetic recording medium does not contain an interlayer (IL) that is different from the hcp SUL and provides a [0002] growth orientation in the magnetic layer. Preferably, a shape anisotropy, (2πMₛ) is larger than a magnetocrysalline anisotropy (K₁), orienting a magnetic moment along a film plane of the magnetic layer. Preferably, the hcp SUL comprises CoFe and one or more elements selected from the group consisting of Ni, Al, Si, Ti, V, Cr, Zr, Nb, Mo, Ru, Rh, Pd, Ag, Hf, Ta, W, Re, Ir, Pt, and Au. Preferably, the hcp SUL comprises CoFe and one or more elements selected from the group consisting of Cr, Ru, and Re. Preferably, the hcp SUL comprises Co₁₀₀₋ₓFeₓ (x≦30) and one or more elements selected from the group consisting of Ni, Al, Si, Ti, V, Cr, Zr, Nb, Mo, Ru, Rh, Pd, Ag, Hf, Ta, W, Re, Ir, Pt, and Au. Preferably, the hcp SUL comprises Co₁₀₀₋ₓFeₓ (x≦30) and one or more elements selected from the group consisting of Cr, Ru, and Re.

Another embodiment relates to a perpendicular magnetic recording medium comprising a substrate, a hcp soft underlayer (SUL), and a magnetic layer, wherein the hcp SUL has the following properties: 1) has a hcp crystal structure, 2) is ferromagnetic, 3) has a saturation magnetization (Mₛ) of greater than 100 emu/cm³, 4) has a shape anisotropy (2πMₛ) larger than a magnetocrysalline anisotropy (K₁), orienting the magnetic moment along a film plane of the magnetic layer, 5) has an in-plane coercivity (H_{c}) of less than 10 Oe, and 6) does not have stripe domains.

Another embodiment of the invention relates to a method of manufacturing a perpendicular magnetic recording medium comprising obtaining a substrate, depositing a hcp soft underlayer (SUL), and depositing a magnetic layer, wherein the hcp SUL is adapted to create a [0002] growth orientation in the magnetic layer and to enhance a magnetic head field during writing of data to the magnetic layer; further wherein the perpendicular magnetic recording medium does not contain an interlayer (IL) that is different from the hcp SUL and provides a [0002] growth orientation in the magnetic layer.

As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 shows (a) longitudinal and (b) perpendicular recording bits.

FIG. 2 shows a design of a perpendicular recording medium having a single hcp soft underlayer of the embodiments of the invention.

FIGS. 3 and 4 show that in the embodiments of the invention, the shape anisotropy is greater than the magnetocrystalline anisotropy.

FIG. 5 shows that the in-plane coercivity of the hcp underlayer of the embodiments of the invention.

FIG. 6 shows that polarization resistance of the Co-containing hcp soft underlayer increases with the addition Ru and Fe, while the polarization resistance decreases with the addition of Re.

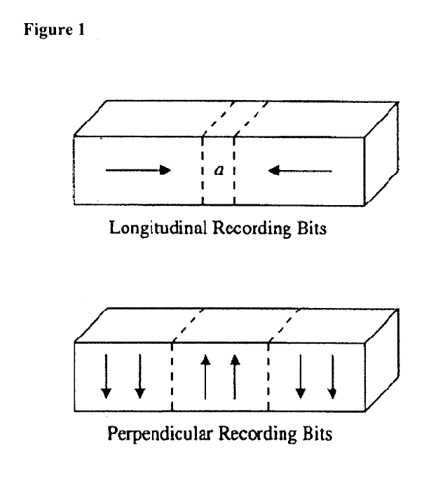

### DETAILED DESCRIPTION

The embodiments of the invention provide magnetic recording media suitable for high areal recording density exhibiting high SMNR. The embodiments of the invention achieve such technological advantages by forming a soft underlayer. A “soft magnetic material” is a material that is easily magnetized and demagnetized. As compared to a soft magnetic material, a “hard magnetic” material is one that neither magnetizes nor demagnetizes easily.

The underlayer is “soft” because it is made up of a soft magnetic material, which is defined above, and it is called an “underlayer” because it resides under a recording layer. In a preferred embodiment, the soft layer is amorphous. The term “amorphous” means that the material of the underlayer exhibits no predominant sharp peak in an X-ray diffraction pattern as compared to background noise. The “amorphous soft underlayer” of the embodiments of the invention encompasses nanocrystallites in amorphous phase or any other form of a material so long the material exhibits no predominant sharp peak in an X-ray diffraction pattern as compared to background noise.

When soft underlayers are fabricated by magnetron sputtering on disk substrates, there are several components competing to determine the net anisotropy of the underlayers: effect of magnetron field, magnetostriction of film and stress originated from substrate shape, etc. The soft magnetic underlayer can be fabricated as single layers or a multilayer.

A seedlayer could be optionally included in the embodiments of this invention. A seedlayer is a layer lying in between the substrate and the underlayer. Proper seedlayer can also control anisotropy of the soft underlayer by promoting microstructure that exhibit either short-range ordering under the influence of magnetron field or different magnetostriction. A seedlayer could also alter local stresses in the soft underlayer.

Preferably, in the underlayer of the perpendicular recording medium of the embodiments of the invention, an easy axis of magnetization is directed in a direction substantially transverse to a traveling direction of the magnetic head. This means that the easy axis of magnetization is directed more toward a direction transverse to the traveling direction of the read-write head than toward the traveling direction. Also, preferably, the underlayer of the perpendicular recording medium has a substantially radial or transverse anisotropy, which means that the domains of the soft magnetic material of the underlayer are directed more toward a direction transverse to the traveling direction of the read-write head than toward the traveling direction. In one embodiment, the direction transverse to the traveling direction of the read-write head is the direction perpendicular to the plane of the substrate of the recording medium.

In accordance with embodiments of this invention, the substrates that may be used in the embodiments of the invention include glass, glass-ceramic, NiP/aluminum, metal alloys, plastic/polymer material, ceramic, glass-polymer, composite materials or other non-magnetic materials. Glass-ceramic materials do not normally exhibit a crystalline surface. Glasses and glass-ceramics generally exhibit high resistance to shocks.

A preferred embodiment of this invention is a perpendicular recording medium comprising at least two amorphous soft underlayers with a spacer layer between the underlayers and a recording layer. The amorphous soft underlayer should preferably be made of soft magnetic materials and the recording layer should preferably be made of hard magnetic materials. The amorphous soft underlayer is relatively thick compared to other layers. The interlayer can be made of more than one layer of non-magnetic materials. The purpose of the interlayer is to prevent an interaction between the amorphous soft magnetic underlayer and recording layer. The interlayer could also promote the desired properties of the recording layer.

The underlayer and magnetic recording layer could be sequentially sputter deposited on the substrate, typically by magnetron sputtering, in an inert gas atmosphere. A carbon overcoat could be typically deposited in argon with nitrogen, hydrogen or ethylene. Conventional lubricant topcoats are typically less than about 20 Å thick.

The magnetic recording medium of the embodiments of the invention contains a layer that can resume both roles, that of an interlayer, setting the [0002] growth orientation, and that of SUL. This layer is called hcp SUL. The preferred requirements for hcp SUL are: 1) to have hcp crystal structure, 2) to be ferromagnetic, 3) to have a large saturation magnetization, 4) to have the shape anisotropy, 2πMₛ, larger than its magnetocrysalline anisotropy, orienting the magnetic moment along the film plane, 5) to have small in-plane coercivity, 6) not to have stripe domains, and 7) to be corrosion resistant. This layer may consists of combination of Fe, Co, Ni, Al, Si, Ti, V, Cr, Zr, Nb, Mo, Ru, Rh, Pd, Ag, Hf, Ta, W, Re, Ir, Pt, Au.

Another advantage of amorphous materials as soft underlayer materials is the lack of long-range order in the amorphous material. Without a long-range order, amorphous alloys have substantially no magnetocrystalline anisotropy. The use of amorphous soft underlayer could be one way of reducing noise caused by ripple domains and surface roughness. The surface roughness of the amorphous soft underlayer is preferably below 1 nm, more preferably below 0.5 nm, and most preferably below 0.2 nm.

In accordance with the embodiments of the invention, the test methods for determining different parameters are as follows. If a particular test method has not been explicitly stated below to determine a parameter, then a conventional method used by persons of ordinary skill in this art could be used to determine that parameter.

The advantageous characteristics attainable by the embodiments of the invention are illustrated in the following examples.

### EXAMPLES

All samples described in this disclosure were fabricated with DC magnetron sputtering except carbon films were made with AC magnetron sputtering.

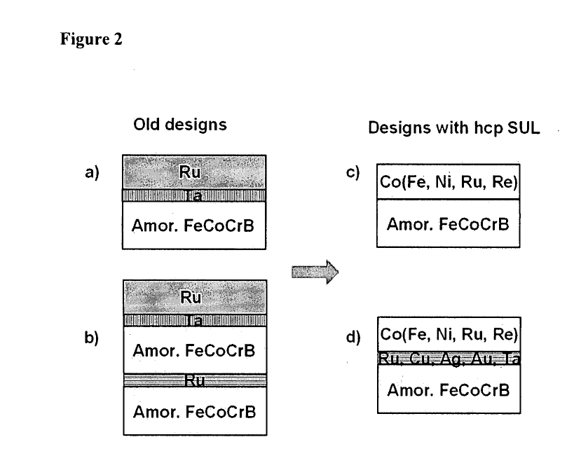

Applicants investigated a recording medium having the structure shown in FIG. 2 including a hcp SUL. The advantages of the hcp SUL layer are: 1) the hcp SUL can have up to 1.5 times larger saturation magnetization, M_{S}, in comparison to currently used amorphous SUL's (from 1000 to 1500 emu/cm³); 2) media design with hcp SUL would be 2 layers less, resulting in a simpler design as shown in FIG. 2; 3) the distance from the head to SUL in the media with hcp SUL is reduced, resulting in better writing performance for cusp heads.

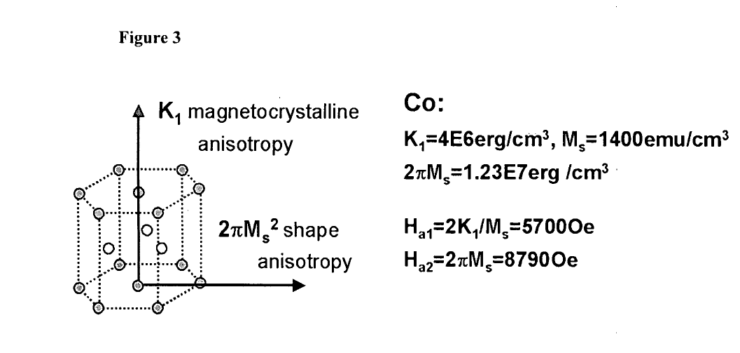

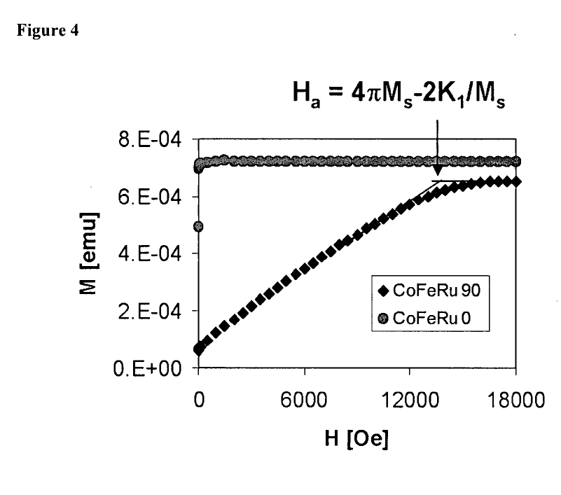

FIGS. 3 and 4 show that even in the case of Co magnetic the shape anisotropy, 2πMₛ, is larger than the magnetocrysalline anisotropy, orienting the magnetic moment along the film plane. Anisotropy perpendicular to the film plane is equal 4πMₛ−2K₁/Mₛ as shown in FIG. 4.

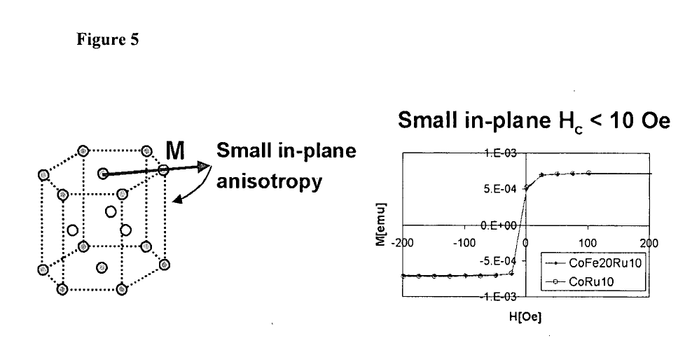

FIG. 5 shows that in-plane coercivity is small, less than 10 Oe. This is due to the six fold in-plane symmetry that leads to a small in-plane anisotropy. Applicants investigated Co₁₀₀₋ₓFeₓ (x≦30) with addition of Ru, Re, Cr. Both Ru and Cr were used to improve corrosion resistance of CoFe and Re to increase melting point of CoFe and therefore surface energy. Results on FeCo (Ru, Re) are summarized in Table 1.

TABLE 1

| | M_{slong} [emu/cm³] | 4πMs [Oe] | Ha [Oe] | Hk [Oe] |
|---|---|---|---|---|
| CoRu10 | 982 | 12334 | 9500 | 2834 |
| CoRu20 | 624 | 7837 | 5500 | 2337 |
| CoRu30 | 280 | 3517 | 1100 | 2417 |
| CoRe10 | 754 | 9470 | 5250 | 4220 |
| CoRe20 | 367 | 4610 | 2000 | 2610 |
| CoRe30 | 15 | 188 | | 188 |
| CoRu5Re5 | 908 | 11404 | 7500 | 3904 |
| CoRu10Re10 | 487 | 6117 | 2750 | 3367 |
| CoFe20 | 1481 | 18601 | 17000 | 1601 |
| CoFe30 | 1546 | 19418 | 18500 | 918 |
| CoFe20Ru10 | 1030 | 12937 | 12500 | 437 |
| CoFe20Ru20 | 305 | 3831 | 3750 | 81 |
| CoFe20Re10 | 808 | 10148 | 10000 | 148 |
| CoFe20Re20 | 131 | 1645 | 1500 | 145 |
| CoFe20Ru5Re5 | 888 | 11153 | 11000 | 153 |
| CoFe20Ru10Re10 | 240 | 3014 | 3000 | 14 |

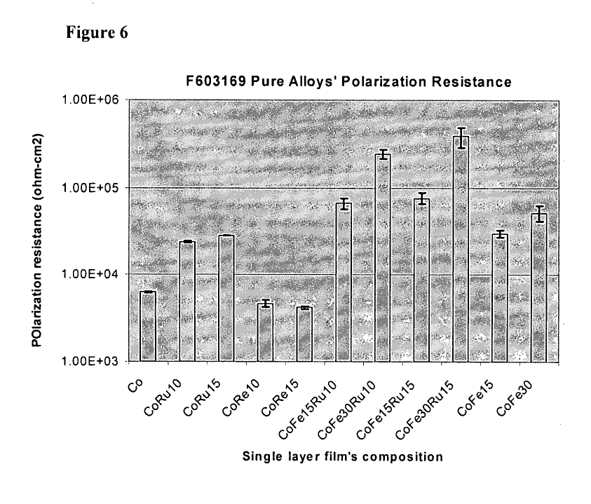

FIG. 6 shows that the polarization resistance of Co increases with an addition of Ru, and Fe. Ru increases electro potential of Co and FeCo oxide presumably passivates Co alloy surface increasing corrosion resistance. On the other hand, Re decreases the polarization resistance of Co as shown in FIG. 6. An addition of Cr can be also used to passivates surface of Co alloy and increase the polarization resistance.

This application discloses several numerical range limitations that support any range within the disclosed numerical ranges even though a precise range limitation is not stated verbatim in the specification because this invention can be practiced throughout the disclosed numerical ranges. Finally, the entire disclosure of the patents and publications referred in this application are hereby incorporated herein in entirety by reference.

1. A perpendicular magnetic recording medium comprising a substrate, a hcp soft underlayer (SUL), and a magnetic layer, wherein the hcp SUL is adapted to create a [0002] growth orientation in the magnetic layer and to enhance a magnetic head field during writing of data to the magnetic layer; further wherein the perpendicular magnetic recording medium does not contain an interlayer (IL) that is different from the hcp SUL and provides a [0002] growth orientation in the magnetic layer.

2. The magnetic recording medium of claim 1, wherein a shape anisotropy, (2πMₛ) is larger than a magnetocrysalline anisotropy (K₁), orienting a magnetic moment along a film plane of the magnetic layer.

3. The magnetic recording medium of claim 1, wherein the hcp SUL comprises CoFe and one or more elements selected from the group consisting of Ni, Al, Si, Ti, V, Cr, Zr, Nb, Mo, Ru, Rh, Pd, Ag, Hf, Ta, W, Re, Ir, Pt, and Au.

4. The magnetic recording medium of claim 1, wherein the hcp SUL comprises CoFe and one or more elements selected from the group consisting of Cr, Ru, and Re.

5. The magnetic recording medium of claim 1, wherein the hcp SUL comprises Co₁₀₀₋ₓFeₓ (x≦30) and one or more elements selected from the group consisting of Ni, Al, Si, Ti, V, Cr, Zr, Nb, Mo, Ru, Rh, Pd, Ag, Hf, Ta, W, Re, Ir, Pt, and Au.

6. The magnetic recording medium of claim 1, wherein the hcp SUL comprises Co₁₀₀₋ₓFeₓ (x≦30) and one or more elements selected from the group consisting of Cr, Ru, and Re.

7. A perpendicular magnetic recording medium comprising a substrate, a hcp soft underlayer (SUL), and a magnetic layer, wherein the hcp SUL has the following properties: 1) has a hcp crystal structure, 2) is ferromagnetic, 3) has a saturation magnetization (Mₛ) of greater than 100 emu/cm³, 4) has a shape anisotropy (2πMₛ) larger than a magnetocrysalline anisotropy (K₁), orienting the magnetic moment along a film plane of the magnetic layer, 5) has an in-plane coercivity (H_{c}) of less than 10 Oe, and 6) does not have stripe domains.

8. The magnetic recording medium of claim 7, wherein the hcp SUL comprises CoFe and one or more elements selected from the group consisting of Ni, Al, Si, Ti, V, Cr, Zr, Nb, Mo, Ru, Rh, Pd, Ag, Hf, Ta, W, Re, Ir, Pt, and Au.

9. The magnetic recording medium of claim 7, wherein the hcp SUL comprises CoFe and one or more elements selected from the group consisting of Cr, Ru, and Re.

10. The magnetic recording medium of claim 7, wherein the hcp SUL comprises Co₁₀₀₋ₓFeₓ (x≦30) and one or more elements selected from the group consisting of Ni, Al, Si, Ti, V, Cr, Zr, Nb, Mo, Ru, Rh, Pd, Ag, Hf, Ta, W, Re, Ir, Pt, and Au.

11. The magnetic recording medium of claim 7, wherein the hcp SUL comprises Co₁₀₀₋ₓFeₓ (x≦30) and one or more elements selected from the group consisting of Cr, Ru, and Re.

12. A method of manufacturing a perpendicular magnetic recording medium comprising obtaining a substrate, depositing a hcp soft underlayer (SUL), and depositing a magnetic layer, wherein the hcp SUL is adapted to create a [0002] growth orientation in the magnetic layer and to enhance a magnetic head field during writing of data to the magnetic layer; further wherein the perpendicular magnetic recording medium does not contain an interlayer (IL) that is different from the hcp SUL and provides a [0002] growth orientation in the magnetic layer.

13. The method of claim 12, wherein a shape anisotropy, (2πMₛ) is larger than a magnetocrysalline anisotropy (K₁), orienting a magnetic moment along a film plane of the magnetic layer.

14. The method of claim 12, wherein the hcp SUL comprises CoFe and one or more elements selected from the group consisting of Ni, Al, Si, Ti, V, Cr, Zr, Nb, Mo, Ru, Rh, Pd, Ag, Hf, Ta, W, Re, Ir, Pt, and Au.

15. The method of claim 12, wherein the hcp SUL comprises CoFe and one or more elements selected from the group consisting of Cr, Ru, and Re.

16. The method of claim 12, wherein the hcp SUL comprises Co₁₀₀₋ₓFeₓ (x≦30) and one or more elements selected from the group consisting of Ni, Al, Si, Ti, V, Cr, Zr, Nb, Mo, Ru, Rh, Pd, Ag, Hf, Ta, W, Re, Ir, Pt, and Au.

17. The method of claim 12, wherein the hcp SUL comprises Co₁₀₀₋ₓFeₓ (x≦30) and one or more elements selected from the group consisting of Cr, Ru, and Re.

18. The method of claim 12, wherein the hcp SUL has the following properties: 1) has a hcp crystal structure, 2) is ferromagnetic, 3) has a saturation magnetization (Mₛ) of greater than 100 emu/cm³, 4) has a shape anisotropy (2πMₛ) larger than a magnetocrysalline anisotropy (K₁), orienting the magnetic moment along a film plane of the magnetic layer, 5) has an in-plane coercivity (H_{c}) of less than 10 Oe, and 6) does not have stripe domains.
